(19) United States
(12) Patent Application Publication
(10) Pub. No.: US 2005/0008743 A1
(43) Pub. Date: Jan. 13, 2005

(54) Food preportioning bag

(76) Inventor: Douglas P. Marquis, Deerfield, IL (US)

Correspondence Address: James P. Ryther;Piper Rudnick LLP, P.O. Box 64807, Chicago, IL, 60664-0807, US

(21) Appl. No.: 10/900,920

(22) Filed: Jul. 28, 2004

Related U.S. Application Data
(62) Division of application No. 08/884,146, filed on Jun. 27, 1997, now abandoned.

(51) Int. Cl. A23L 1/00

(52) U.S. Cl. 426/383

(57) ABSTRACT

A preportioning bag used in food operations wherein a bulk food supply is divided into portions of smaller size. The smaller size portions are then placed in individual bags and stored in a refrigerator or the like until ready for use. Each bag has the days of the week printed thereon in at least one language and the days are color-coded. The day of preportioning or the last day for possible use is marked on the bag to facilitate removal from storage.

### CROSS-REFERENCE TO RELATED APPLICATION

This application is a division of presently pending application Ser. No. 08/884,146, filed Jun. 27, 1997.

### BACKGROUND OF THE INVENTION

This invention relates to a food preportioning bag of the type used in food handling facilities such as restaurants. In a typical situation, food such as shrimp or chicken is received in bulk form. In off-peak hours, employees divide the food into individual portions so that when the restaurant or the like is busy, there will be no time wasted preparing such portions.

It has become a common practice to store the individual portions in separate plastic bags to preserve freshness and for ease of handling. Since it was recognized that the preparation of the bulk food and the preportioning thereof might occur on a different day through the use thereof, a system needed to be developed which would insure that the oldest product in storage was used first. Since it was seldom, if ever, desirable to use such food more than one week after storage, such systems evolved into simply indicating the day on which the portioning took place or by which the food must be used. “Tuesday” food in storage would then be used before “Wednesday” food, etc.

Marking pens could be utilized to write the day on the bags but this method is unreliable due to erasure or smudging, and the method is also time consuming. Adhesive labels, each having a separate day printed thereon became a more acceptable practice. Such labels were also color coded so that workers would be able to recognize a “Wednesday” label by its red color; a “Thursday” label by its brown color, etc. This facilitated selection of the correct day label from the inventory of labels for application to the bags of preportioned food, and it also facilitated selection of the bags from storage on or before the “use by” day.

The application of the adhesive labels still added time to the preportioning operation which is a problem recognized in Tenner et al. application Ser. No. 08/622,612 filed on Mar. 25, 1996 and assigned to Stripper Bags, Inc. (now U.S. Pat. No. 5,642,605 issued on Jul. 1, 1997). The plastic bags disclosed therein each have a separate day of the week printed thereon, the printing preferably being in the same separate colors that were used on the adhesive labels. With these bags, it was only necessary to select from the inventory of bags those marked with the day that the preportioning is taking place or the “use by” day. This eliminated the time needed for applying a label to each bag.

### SUMMARY OF THE INVENTION

This invention relates to food preportioning bags which enable still further efficiencies in the portioning and storage of food initially in bulk form. In particular, the invention relates to bags which are all of the same design so that it is not necessary to hold in inventory separate sets of bags with each set dedicated to one day of the week. In the alternative, it is not necessary to maintain separate sets of adhesive labels with each set dedicated to a single day of the week.

The bags of the invention each have printed thereon at least several days of the week and preferably all seven days of the week. Each day is printed in a different color preferably using the color-scheme corresponding with the practice used in the prior art for “day” labels and bags.

The bags may be mounted on a “saddle” for ease of use. Also in accordance with prior art practice, the bags of the invention are adapted for adding information, such as the date or special instructions, with a marking pen or the like. Furthermore, the marking pen can be used to specify the day of preportioning or “use by” day by, for example, by checking off or forming a circle around one of the days printed on the bag. Finally, and also in accordance with prior art practice, the days may be printed on the bags in two or more languages.

### DESCRIPTION OF THE DRAWINGS

FIG. 1 is perspective view of the bags of the invention shown in assembled relationship on a saddle structure; and,

FIG. 2 is a plan view of the bag of the invention.

### DESCRIPTION OF THE PREFERRED EMBODIMENTS

The drawings illustrate a plastic bag 10 having a main body portion 12 with closed side edges 14 and a closed bottom edge 16. A front overlay 18 may be folded along the edge 20 into overlying relationship with the front wall of the main body portion and secured at its sides 22 by heat sealing to the main body portion. The back wall of the main body portion includes an extension 24 which may be tucked within the bag after filling. The free edge 26 of the overlay 18 is then pulled over the open top of the bag to form a closure.

As noted, bags of this type, and of other designs, have been used in the past for preportioning and storing of food products. In one prior art system an inventory of adhesive labels, each having a particular day of the week printed thereon, was provided so that a label could be selected depending on the day of the week the portioning took place or the “use by” day. In another prior art system, the inventory consisted of sets of bags with each bag in a set having a particular day printed thereon.

The bags of this invention have a plurality of days printed thereon, preferably all seven days as shown at 30. A separate printed block 32 is provided for each day and spaces 34 are provided to print the day in different languages. Additional spaces 36 are available to write in other information where desired. Each day preferably is also printed in a different color with the selected colors following conventional practice as follows:

| | |
|---|---|
| Sunday | Black |
| Monday | Blue |
| Tuesday | Yellow |
| Wednesday | Red |
| Thursday | Brown |
| Friday | Green |
| Saturday | Orange |

Also in order to simplify recognition, the days may be printed in different languages such as English, Spanish and French.

With the bags of this invention, there is no need to maintain an inventory of different labels or of bags with different days printed thereon. Thus, the bags of the invention are all the same and are useful for all preportioning operations.

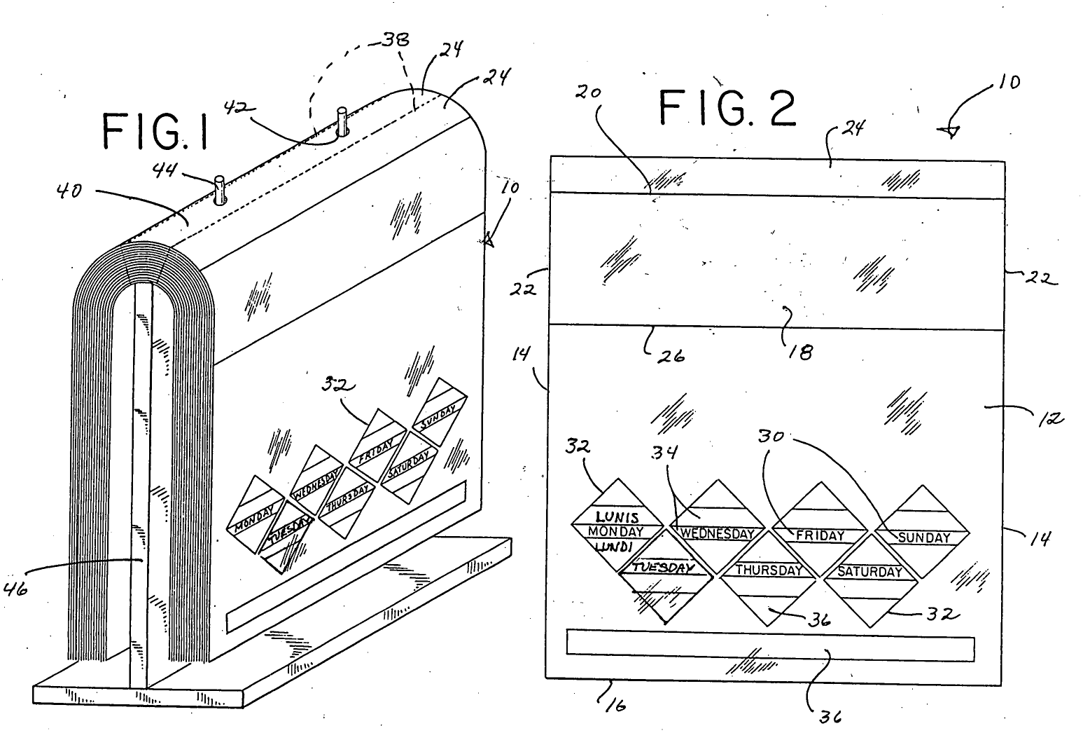

In one form of the practice of the invention, the bags are manufactured in the form shown in FIG. 1. Specifically, the extension 24 of each bag is attached along a perforated line 38 to a central plastic strip 40. The strip 49 defines openings 42 which receive pegs 44 of saddle structure 46. As illustrated, a bag 10 is releasably attached to each side edge of the strip 40 so that the bags are accessible on both sides of the saddle structure.

During a preportioning operation, workers will fill a bag while on the saddle and then tear the bag off. Alternatively, workers will simply tear a bag away from the saddle structure and fill it with the desired portion. Either before or after filling, and using a marking pen, the block 32 enclosing the printed day of the preportioning operation can be provided with a check mark or marked in any other desirable fashion. Alternatively, the day by which the food should be used could be marked, if preferred. Other information can then also be marked on the bag as desired.

It will be understood that various changes and additions may be made in the subject matter of the invention without departing from the spirit of the invention particularly as defined in the following claims.

1. A method for preportioning a bulk food supply comprising the steps of:
a) providing a plurality of bags defining exposed side walls and printing on at least one side wall comprising a plurality of separate printed blocks referencing the seven days of the week, each day of the week being printed within a separate block;
b) dividing the bulk food supply in smaller size, individual portions;
c) placing each of the smaller size, individual portions in a separate one of said plurality of bags; and
d) marking one of said blocks on each of said plurality of bags to establish a date by which contents of each of said plurality of bags should be used.

2. The method of claim 1 wherein each day of the week is printed on the plurality of bags in a different color to facilitate identification of the marked day of the week.

3. The method of claim 1 wherein step d) is accomplished by using a marking pen.
